(19) United States
(12) Patent Application Publication
(10) Pub. No.: US 2025/0328776 A1
(43) Pub. Date: Oct. 23, 2025

(54) CONSTRUCTION AND TRAINING OF SIMPLIFIED BIPOLAR MORPHOLOGICAL NEURAL NETWORK USING LAYER-BY-LAYER KNOWLEDGE DISTILLATION

(71) Applicant: Smart Engines Service, LLC, Moscow (RU)

(72) Inventors: Mikhail Vladimirovich ZINGERENKO, Moscow (RU); Elena Evgenyevna LIMONOVA, Moscow (RU)

(21) Appl. No.: 18/929,478

(22) Filed: Oct. 28, 2024

(30) Foreign Application Priority Data
Apr. 22, 2024 (RU) 2024110985

(51) Int. Cl. G06N 3/096; G06N 3/045

(52) U.S. Cl. CPC G06N 3/096; G06N 3/045

(57) ABSTRACT

Bipolar morphological (BM) neural networks can be used to improve performance over classical artificial neural networks, at the inference stage, using specialized hardware. Accordingly, embodiments introduce a 1.5-branch BM neuron model to increase the computational efficiency of the inference process. However, it can be difficult to train BM neural networks using classical training methods. Therefore, embodiments construct such a 1.5-branch BM neural network using layer-by-layer knowledge distillation. In an embodiment, the construction of the 1.5-branch BM neural network is further improved using maximum approximation.

### CROSS-REFERENCE TO RELATED APPLICATIONS

The present application claims priority to Russian Application No. 2024110985, filed on Apr. 22, 2024, which is hereby incorporated herein by reference as if set forth in full.

### BACKGROUND

### Field of the Invention

The embodiments described herein are generally directed to an artificial neural network, and, more particularly, to constructing and training a simplified bipolar morphological neural network (BMNN) using layer-by-layer knowledge distillation.

### Description of the Related Art

Artificial neural networks are a staple of modern image-recognition systems (see Ref1, Ref2, Ref3). Artificial neural networks are now actively used on mobile processes (see Ref4) and programmable logic integrated circuits (see Ref5). To improve the performance of these artificial neural networks, various approaches have been developed, including quantization (see Ref6), tensor decompositions (see Ref7), removal of weights (see Ref8), and the like.

One approach is to develop special models, for the neurons in the artificial neural network, that utilize simpler operations than classical models (see, e.g., Ref9, Ref10). One example of a special neuron model is the bipolar morphological (BM) neuron (see Ref11, Ref12). Whereas a classical mathematical neuron utilizes multiplication and addition, a bipolar morphological neuron uses addition and maximum (or minimum) operations. Since an addition operation requires less hardware complexity than a multiplication operation, the bipolar morphological neuron is potentially more energy efficient and faster than the classical mathematical neuron. U.S. Patent Pub. No. 2022/0292312, published on Sep. 15, 2022, which is hereby incorporated herein by reference as if set forth in full, describes embodiments of a bipolar morphological neural network (BMNN) comprising bipolar morphological neurons.

One major problem is that it is difficult to train a bipolar morphological neural network using gradient methods based on the backpropagation of error. In particular, due to the use of the maximum operation, only four weight values are changed for each neuron per training iteration. In addition, the structure of the bipolar morphological neuron itself consists of four computational branches, which requires additional resources for implementation. The present disclosure is directed towards addressing this and other issues discovered by the inventors.

### SUMMARY

Systems, methods, and non-transitory computer-readable media are disclosed for constructing and training a simplified bipolar morphological neural network using layer-by-layer knowledge distillation.

In an embodiment, a method comprises using at least one hardware processor to: acquire a supervisor network that comprises a trained first artificial neural network; construct and train a student network, comprising a second artificial neural network, by, for each of a plurality of layers in the supervisor network, in sequence from an input to an output of the supervisor network, transform the layer in the supervisor network into a corresponding bipolar morphological layer in the student network, wherein the bipolar morphological layer comprises at least one 1.5-branch model of a bipolar morphological neuron in which inputs to the bipolar morphological neuron are shifted to positive and weights within the bipolar morphological neuron are shifted to positive, connect an output of the corresponding bipolar morphological layer to an input of a next layer in the supervisor network that is subsequent to the layer, and train both the supervisor network and the student network using a loss function that incorporates an error between the layer in the supervisor network and the corresponding bipolar morphological layer in the student network; and deploy the student network as a bipolar morphological neural network.

Acquiring the supervisor network may comprise training the first artificial neural network. Training the first artificial neural network may comprise supervised learning that utilizes a gradient method with backpropagation of error. Acquiring the supervisor network may comprise receiving the first artificial neural network.

Constructing and training the student network may further comprise, for each of the plurality of layers in the supervisor network, after training both the supervisor network and the student network using the loss function, fixing the layer in the supervisor network and the corresponding bipolar morphological layer in the student network.

Constructing and training the student network may further comprise, for each of the plurality of layers in the supervisor network, connecting an input of the corresponding bipolar morphological layer to an output of an immediately preceding bipolar morphological layer, if any, in the student network.

During construction and training of the student network, each bipolar morphological layer may utilize an approximation of a maximum operation instead of an actual maximum operation. The approximation of the maximum operation may be a log-sum-exp (LSE) function. The method may further comprise using the at least one hardware processor to, after constructing and training the student network and before deploying the student network, convert each approximation of the maximum operation in the bipolar morphological layers of the bipolar morphological neural network to the actual maximum operation. The method may further comprise using the at least one hardware processor to, after converting each approximation of the maximum operation to the actual maximum operation and before deploying the student network, fine-tuning the bipolar morphological neural network.

The error between the layer in the supervisor network and the corresponding bipolar morphological layer in the student network may comprise a measure of error between an output of the layer in the supervisor network and an output of the corresponding bipolar morphological layer in the student network. The measure of error may be a root-mean-square error. The loss function may be defined as:

$$L = β {\sum }_{i = 1}^{m} {H}_{mse} ( {y}_{s}^{i} , {y}_{t}^{i} ) + α \{ {H}_{c r o s s} ( {y}_{s} , {y}_{gt} ) + {H}_{c r o s s} ( {y}_{t} , {y}_{gt} ) \}$$

wherein L is the loss function, α and β are temperature parameters that control randomness, Hₘₛₑ is a root-mean-square error (RMSE) function, H_{cross} is a cross entropy function, m is a number of layers in the plurality of layers,

$${y}_{s}^{i}$$

is an output of layer i of the supervisor network,

$${y}_{t}^{i}$$

is an output of layer i of the student network, yₛ is an output of the supervisor network, yₜ is an output of the student network, and y_{gt} is a target output.

Each 1.5-branch model of the bipolar morphological neuron may be defined as:

$$f ( \vec{x} ) = ϕ \{ exp {max}_{i = 1}^{n} [ ln ( {x}_{i} + Δ {x}_{i} ) + ln ( {v}_{i} + Δ {v}_{i} ) ] - Δ {x}_{i} {v}_{i} - Δ {v}_{i} {x}_{i} - Δ {x}_{i} Δ {v}_{i} \}$$

wherein ƒ(⋅) is the neuron, ϕ is an activation function, x is an input vector of input data, exp is an exponential function, max is a maximum operation, ln is a natural logarithm, n is a length of the input vector, xᵢ is a value at position i in the input vector, Δxᵢ is a displacement of xᵢ, v is a weight vector, vᵢ is a value at position i in the weight vector, and Δvᵢ is a displacement of vᵢ.

The student network may be trained to perform an image-processing task. The image-processing task may comprise recognizing at least one object within an input image. The image-processing task may comprise classifying an input image into one of a plurality of classifications. The first artificial neural network may be a convolutional neural network, wherein each of the plurality of layers is a convolutional layer.

Training both the supervisor network and the student network may utilize a gradient method that is based on backpropagating error calculated by the loss function.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example processing system, by which one or more of the processes described herein may be executed, according to an embodiment;

FIG. 2 illustrates an example process for training a bipolar morphological neural network, according to an embodiment;

FIG. 3 illustrates an example process for training a bipolar morphological neural network using layer-by-layer knowledge distillation, according to an embodiment;

FIGS. 4A-4D illustrate the operation of a process for training a bipolar morphological neural network using layer-by-layer knowledge distillation, according to an example;

FIG. 5 illustrates an example process for training a bipolar morphological neural network using layer-by-layer knowledge distillation and maximum approximation, according to an embodiment; and

FIG. 6 illustrates the mean-square error (MSE) over values of a temperature parameter for each of three continuous approximations of a maximum operation, according to an experiment.

### DETAILED DESCRIPTION

In an embodiment, systems, methods, and non-transitory computer-readable media are disclosed for constructing and training a simplified bipolar morphological neural network using layer-by-layer knowledge distillation. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. SYSTEM OVERVIEW

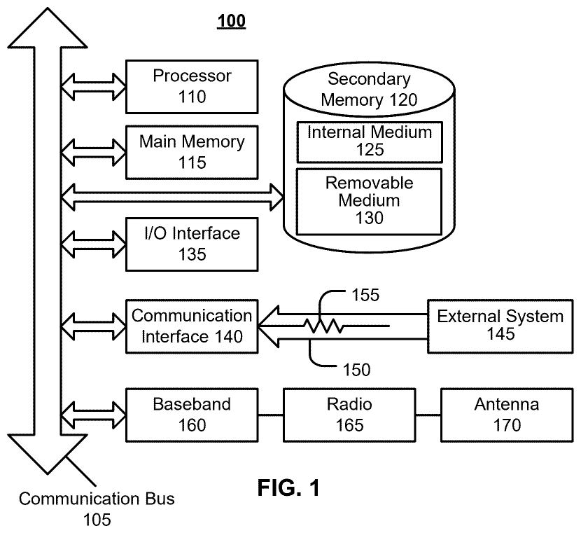

FIG. 1 is a block diagram illustrating an example wired or wireless system 100 that may be used in connection with various embodiments described herein. For example, system 100 may be used as or in conjunction with one or more of the processes (e.g., one or more software modules of an application implementing the disclosed processes) described herein, including any methods or functions described herein. System 100 can be a server (e.g., which services requests over one or more networks, including, for example, the Internet), a personal computer (e.g., desktop, laptop, or tablet computer), a mobile device (e.g., smartphone), a controller (e.g., in an autonomous vehicle, robot, etc.), or any other processor-enabled device that is capable of wired or wireless data communication. Other computer systems and/or architectures may be also used, as will be clear to those skilled in the art.

System 100 may comprise one or more processors 110. Processor(s) 110 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 110. Examples of processors which may be used with system 100 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 110 may be connected to a communication bus 105. Communication bus 105 may include a data channel for facilitating information transfer between storage and other peripheral components of system 100. Furthermore, communication bus 105 may provide a set of signals used for communication with processor 110, including a data bus, address bus, and/or control bus (not shown). Communication bus 105 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 100 may comprise main memory 115. Main memory 115 provides storage of instructions and data for programs executing on processor 110, such as one or more of the functions and/or modules discussed herein. It should be understood that programs stored in the memory and executed by processor 110 may be written and/or compiled according to any suitable language, including without limitation C/C++, Java, JavaScript, Perl, Python, Visual Basic, .NET, and the like. Main memory 115 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 100 may comprise secondary memory 120. Secondary memory 120 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 100. The computer software stored on secondary memory 120 is read into main memory 115 for execution by processor 110. Secondary memory 120 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 120 may include an internal medium 125 and/or a removable medium 130. Internal medium 125 and removable medium 130 are read from and/or written to in any well-known manner. Internal medium 125 may comprise one or more hard disk drives, solid state drives, and/or the like. Removable storage medium 130 may be, for example, a magnetic tape drive, a compact disc (CD) drive, a digital versatile disc (DVD) drive, other optical drive, a flash memory drive, and/or the like.

System 200 may comprise an input/output (I/O) interface 135. I/O interface 135 provides an interface between one or more components of system 100 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 100 may comprise a communication interface 140. Communication interface 140 allows software to be transferred between system 100 and external devices (e.g. printers), networks, or other information sources. For example, computer-executable code and/or data may be transferred to system 100, over one or more networks (e.g., including the Internet), from a network server via communication interface 140. Examples of communication interface 140 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 100 with a network or another computing device. Communication interface 140 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 140 is generally in the form of electrical communication signals 155. These signals 155 may be provided to communication interface 140 via a communication channel 150 between communication interface 140 and an external system 145. In an embodiment, communication channel 150 may be a wired or wireless network, or any variety of other communication links. Communication channel 150 carries signals 155 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 115 and/or secondary memory 120. Computer-executable code can also be received from an external system 145 via communication interface 140 and stored in main memory 115 and/or secondary memory 120. Such computer-executable code, when executed, enable system 100 to perform the various functions of the disclosed embodiments as described elsewhere herein.

In an embodiment that is implemented using software, the software may be stored on a computer-readable medium and initially loaded into system 100 by way of removable medium 130, I/O interface 135, or communication interface 140. In such an embodiment, the software is loaded into system 100 in the form of electrical communication signals 155. The software, when executed by processor 110, preferably causes processor 110 to perform one or more of the processes and functions described elsewhere herein.

System 100 may comprise wireless communication components that facilitate wireless communication over a voice network and/or a data network (e.g., in the case of a mobile device, such as a smart phone). The wireless communication components comprise an antenna system 170, a radio system 165, and a baseband system 160. In system 100, radio frequency (RF) signals are transmitted and received over the air by antenna system 170 under the management of radio system 165.

In an embodiment, antenna system 170 may comprise one or more antennae and one or more multiplexors (not shown) that perform a switching function to provide antenna system 170 with transmit and receive signal paths. In the receive path, received RF signals can be coupled from a multiplexor to a low noise amplifier (not shown) that amplifies the received RF signal and sends the amplified signal to radio system 165.

In an alternative embodiment, radio system 165 may comprise one or more radios that are configured to communicate over various frequencies. In an embodiment, radio system 165 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 165 to baseband system 160.

If the received signal contains audio information, then baseband system 160 decodes the signal and converts it to an analog signal. Then the signal is amplified and sent to a speaker. Baseband system 160 also receives analog audio signals from a microphone. These analog audio signals are converted to digital signals and encoded by baseband system 160. Baseband system 160 also encodes the digital signals for transmission and generates a baseband transmit audio signal that is routed to the modulator portion of radio system 165. The modulator mixes the baseband transmit audio signal with an RF carrier signal, generating an RF transmit signal that is routed to antenna system 170 and may pass through a power amplifier (not shown). The power amplifier amplifies the RF transmit signal and routes it to antenna system 170, where the signal is switched to the antenna port for transmission.

Baseband system 160 is communicatively coupled with processor(s) 110, which have access to memory 115 and 120. Thus, software can be received from baseband processor 160 and stored in main memory 115 or in secondary memory 120, or executed upon receipt. Such software, when executed, can enable system 100 to perform the various functions of the disclosed embodiments.

### 2. INTRODUCTION

In an embodiment, bipolar morphological neurons are used to approximate classical mathematical neurons, to thereby reduce the computational complexity of an artificial neural network. Each bipolar morphological neuron utilizes addition and maximum (or minimum) operations, instead of the multiplication and addition operations in classical mathematical neurons. In an embodiment, the bipolar morphological neuron may utilize the 1.5-branch model disclosed elsewhere herein. This novel 1.5-branch model enhances the computational efficiency of the bipolar morphological neuron, relative to state-of-the-art bipolar morphological neurons. In addition, the artificial neural network may be trained according to a new approach that is based on knowledge distillation and/or continuous approximations of the maximum operation.

Experiments demonstrated that the resulting bipolar morphological neural network produces results that are not worse than the results of a classical artificial neural network. Experiments were performed on the Modified National Institute of Standards and Technology (MNIST) dataset, to recognize handwritten digits using an architecture that was similar to LeNet. LeNet is a convolutional neural network (CNN) architecture proposed by LeCun et al., “Gradient-based learning applied to document recognition,” Proceedings of the IEEE, 86 (11): 2278-2324, doi: 10.1109/5.726791, which is hereby incorporated herein by reference as if set forth in full. Experiments were also performed on the Canadian Institute for Advanced Research, 10 classes, (CIFAR10) dataset, to classify images using a residual neural network (ResNet) ResNet, and specifically the ResNet-22 architecture. The experiments demonstrated that disclosed embodiments achieve 99.45% classification accuracy on the LeNet-like model, which is the same accuracy as provided by the classical artificial neural network, and 86.69% classification accuracy on the ResNet-22 model, compared to 86.43% accuracy for the classical artificial neural network.

### 3. BIPOLAR MORPHOLOGICAL NEURON

A model of the classical mathematical neuron can be represented as:

$$f ( \vec{x} ) = ϕ ( {\sum }_{i = 1}^{n} {ω}_{i} {x}_{i} - {ω}_{0} ) , \qquad Equation ( 1 )$$

wherein ƒ(⋅) is the neuron, ϕ is the activation function, x is an input vector of input data, xᵢ is the value at position i in the input vector, n is the length of the input vector, ωᵢ is the weight for position i in the input vector, and ω₀ is a bias.

This model of the classical mathematical neuron can be approximated by a bipolar morphological neuron having the form:

$$f ( \vec{x} ) = ϕ \{ \qquad Equation ( 2 )$$

$$exp {max}_{i = 1}^{n} ( ln {x}_{i}^{+} + {v}_{i}^{+} )$$

$$- exp {max}_{i = 1}^{n} ( ln {x}_{i}^{+} + {v}_{i}^{-} )$$

$$- exp {max}_{i = 1}^{n} ( ln {x}_{i}^{-} + {v}_{i}^{+} )$$

$$+ exp {max}_{i = 1}^{n} ( ln {x}_{i}^{-} + {v}_{i}^{-} )$$

$$+ {v}_{0} \}$$

$${x}_{i}^{+} = \{ \begin{matrix}0 , & x < 0 \\ {x}_{i} , & x \geq 0\end{matrix}$$

$${x}_{i}^{-} = \{ \begin{matrix}- {x}_{i} , & x < 0 \\ 0 , & x \geq 0\end{matrix}$$

$${v}_{i}^{+} = \{ \begin{matrix}ln ( \vert {ω}_{i} \vert ) , & {ω}_{i} > 0 \\ - ∞ , & {ω}_{i} \leq 0\end{matrix}$$

$${v}_{i}^{-} = \{ \begin{matrix}ln ( \vert {ω}_{i} \vert ) , & {ω}_{i} < 0 \\ - ∞ , & {ω}_{i} \geq 0\end{matrix}$$

wherein exp is the exponential function, max is the maximum operation that identifies a maximum of a set of input values, ln is the natural logarithm,

$${v}_{i}^{+}$$

is a weight for the positive part

$${x}_{i}^{+} of {x}_{i} , {v}_{i}^{-}$$

is a weight for the negative part

$${x}_{i}^{-} of {x}_{i} ,$$

and v₀ is the bias.

### 4. LAYER-BY-LAYER TRANSFORMATION AND FINE-TUNING

From Equation (2), it apparent that the structure of the bipolar morphological neuron has four computational branches. This is a result of limitations imposed by the domain of logarithm. Due to the use of maximum operations, four values of weights are updated, for each bipolar morphological neuron, during the backpropagation of error in each training iteration. Consequently, it is difficult to train the bipolar morphological neurons using classical training methods. Accordingly, in an embodiment, a layer-by-layer transformation of an artificial neural network to a bipolar morphological neural network is performed, with subsequent fine-tuning of the resulting bipolar morphological neural network using classical training methods.

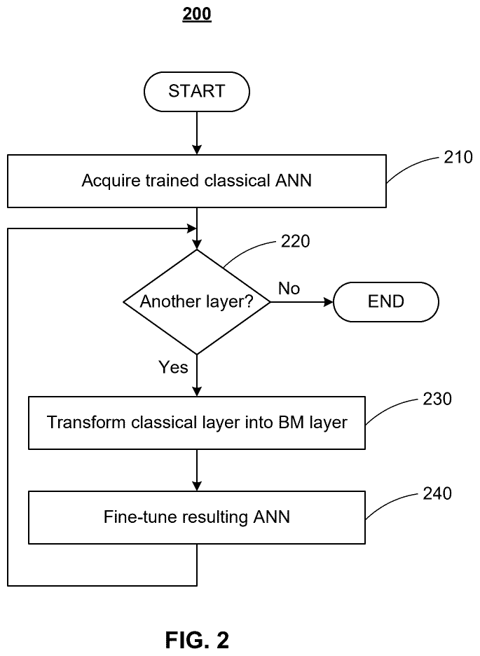

FIG. 2 illustrates an example process 200 for training a bipolar morphological neural network, according to an embodiment. Process 200 may be implemented in software (e.g., in system 100), in hardware, or in a combination of software and hardware. While process 200 is illustrated with a certain arrangement and ordering of subprocesses, process 200 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Initially, in subprocess 210, a trained classical artificial neural network is acquired. Subprocess 210 may comprise training the classical artificial neural network using a classical training method. For example, the artificial neural network may be a convolutional neural network, or other type of artificial neural network with linear layers. It should be understood that, in an embodiment in which the artificial neural network is a convolutional neural network, the artificial neural network will comprise a plurality of convolutional layers. The artificial neural network may be trained on a training dataset with supervised learning, for example, using a gradient method that is based on the backpropagation of error. Alternatively, subprocess 210 may simply comprise receiving the trained classical artificial neural network. In any case, it should be understood that, at this point, the layers of the artificial neural network comprise classical mathematical neurons.

In subprocess 220, it is determined whether or not another classical layer (e.g., convolutional or linear layer) remains to be transformed. In particular, subprocess 220 will iterate through each layer that is to be transformed from a classical layer, comprising classical mathematical neurons, into a bipolar morphological layer, comprising bipolar morphological neurons. In an embodiment, all convolutional and/or linear layers in the artificial neural network are transformed. Subprocess 220 may iterate through the layers in sequence from an input to an output of the artificial neural network. In other words, subprocess 220 may start with the first layer to be transformed and proceed successively through the layers, layer by layer, up to and including the final layer to be transformed. When determining that another layer remains to be transformed (i.e., “Yes” in subprocess 220), process 200 may select the next layer to be transformed and proceed to subprocess 230. Otherwise, when determining that no more layers remain to be transformed (i.e., “No” in subprocess 220) (i.e., all layers have been transformed), process 200 may end.

In subprocess 230, the layer that was selected in the most recent iteration of subprocess 220 is transformed from the classical layer into the bipolar morphological layer. In particular, each neuron in the layer may be transformed from Equation (1), representing the classical mathematical neuron, to Equation (2), representing the bipolar morphological layer. It should be understood that, during this conversion, weights w will be transformed into weights v.

In subprocess 240, the resulting artificial neural network, including the bipolar morphological layer(s), transformed in the most recent iteration of subprocess 230 and any prior iterations of subprocess 230, may be fine-tuned. In other words, process 200 implements a combination of transformation and fine-tuning, layer by layer, until all layers have been transformed, thereby producing the complete bipolar morphological neural network, which may then be evaluated and/or deployed.

### 5. SIMPLIFIED 1.5-BRANCH MODEL OF BIPOLAR MORPHOLOGICAL NEURON

Traditionally, to construct a bipolar morphological neuron, the scalar product of the inputs x and weights v is decomposed into four sums, with each sum operating on the inputs of the same sign (i.e., positive or negative) and weights of the same sign (i.e., positive or negative). Then, each sum is approximated using bipolar morphological approximation, since bipolar morphological approximation can process data of the same sign.

This four-branch structure, which is also described above with respect to Equation (2), requires additional hardware resources for implementation. Accordingly, in an embodiment, the input vector x and the weight vector v are shifted to the first quadrant to eliminate the need for four computational branches, and produce what is referred to herein as a “1.5-branch” model. In particular, the inputs to the bipolar morphological neuron are shifted to make the inputs positive (e.g., by adding the absolute value of the minimum input value) and the weights of the bipolar morphological neuron are shifted to make them positive (e.g., by adding the absolute value of the minimum weight value). Then, bipolar morphological approximation is performed. This process reduces the bipolar morphological neuron to a single branch. However, the transformation of the inputs and the weights affects the result of the computation, and therefore, the result of the computation must be transformed (e.g., shifted) back using operations (e.g., linear operations). The number of operations, required to transform the result of the computation, is less than the number of operations inside the traditional 4-branch model of the bipolar morphological neuron and depends only on the size of the input. In addition, the values referring to the shift in the weights can be precomputed prior to the inference stage. Thus, these operations are referred to as a half branch, since they are fewer in number than in bipolar morphological approximation. This is why this new bipolar morphological model is referred to herein as a “1.5-branch” model.

This 1.5-branch model of the bipolar morphological neuron can be defined or represented as:

$$Equation ( 3 )$$

$$f ( \vec{x} ) = ϕ \{ exp {max}_{i = 1}^{n} [ ln ( {x}_{i} + Δ {x}_{i} ) + ln ( {v}_{i} + Δ {v}_{i} ) ] - Δ {x}_{i} {v}_{i} - Δ {v}_{i} {x}_{i} - Δ {x}_{i} Δ {v}_{i} \}$$

wherein v is the weight vector, vᵢ is the value at position i in the weight vector (i.e., representing the weight for xᵢ), Δxᵢ is the displacement of xᵢ, and Δvᵢ is the displacement of vᵢ, such that the values under the logarithm sign are positive. The model of the bipolar morphological neuron in Equation (3) is referred to as the “1.5-branch” model because the number of branches has been reduced to one, but additional actions are added to process Δxᵢ and Δvᵢ.

### 6. TRAINING BIPOLAR MORPHOLOGICAL NEURAL NETWORK WITH 1.5-BRANCH NEURONS

A bipolar morphological neural network, with bipolar morphological neurons formed according to the 1.5-branch model, cannot be trained using classical training methods or process 200. Instead, in an embodiment, such a bipolar morphological neural network is trained using layer-by-layer knowledge distillation.

The essence of knowledge distillation is to transfer useful information from a first artificial neural network, referred to as the “supervisor network,” to another artificial neural network, referred to as the “student network” (see Ref13). This information transfer can be performed by modifying the classical loss function to (see Ref14):

$$L = β {\sum }_{i = 1}^{m} {H}_{mse} ( {y}_{s}^{i} , {y}_{t}^{i} ) + α \{ {H}_{cross} ( {y}_{s} , {y}_{t} ) + {H}_{cross} ( {y}_{s} , {y}_{gt} ) \}$$

wherein α and β are temperature parameters that are used to control the randomness of inference, Hₘₛₑ is the root-mean-square error (RMSE) function, H_{cross} is the cross entropy function, m is the number of layers in the artificial neural network (e.g., the same value for both the supervisor and student networks),

$${y}_{s}^{i}$$

is the output of layer i of the supervisor network,

$${y}_{t}^{i}$$

is the output of layer i of the student network, yₛ is the output of the supervisor network, yₜ is the output of the student network, and y_{gt} is the target or reference output (e.g., representing the ground truth). Using the above definition of the loss function, the artificial neural network is trained on standard outputs, and the output of each layer of the student network becomes similar to the output of the corresponding layer in the supervisor network. Notably, knowledge distillation is suitable for a bipolar morphological neural network, since the bipolar morphological neural network is an approximation of the classical artificial neural network.

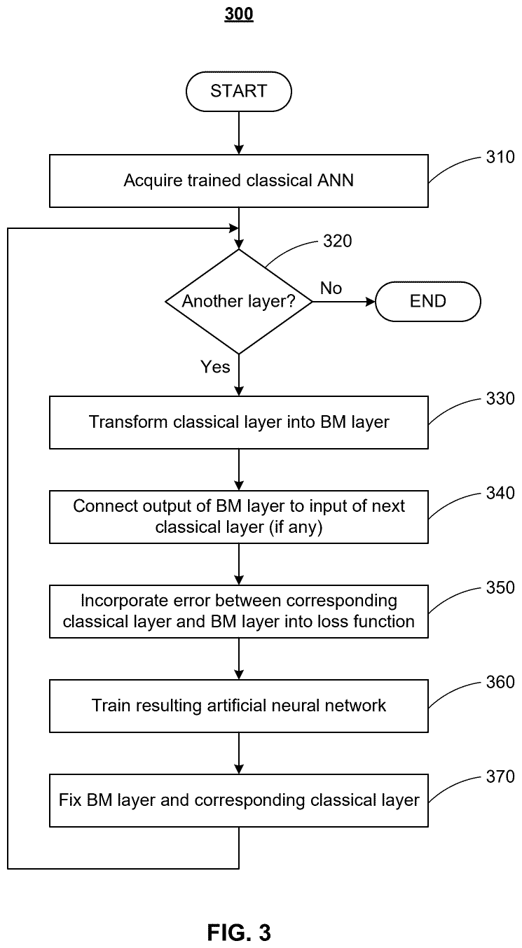

FIG. 3 illustrates an example process 300 for training a bipolar morphological neural network using layer-by-layer knowledge distillation, according to an embodiment. Process 300 may be implemented in software (e.g., in system 100), in hardware, or in a combination of software and hardware. While process 300 is illustrated with a certain arrangement and ordering of subprocesses, process 300 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Initially, in subprocess 310, a supervisor network, comprising a trained classical artificial neural network, is acquired. Subprocess 310 may be similar or identical to subprocess 210 in process 200. Thus, any description of subprocess 210 applies equally to subprocess 310, and therefore, will not be redundantly included herein.

The supervisor network, acquired in subprocess 310, is then used to construct and train a student network, comprising a bipolar morphological neural network, by transforming and training each layer in the supervisor network, in sequence from an input to an output of the supervisor network. In this manner, knowledge from the layers of the supervisor network is distilled into corresponding layers in the student network, layer by layer.

In subprocess 320, it is determined whether or not another classical layer in the supervisor network remains to be transformed. Subprocess 320 may be similar or identical to subprocess 220 in process 200. Thus, any description of subprocess 220 applies equally to subprocess 320, and therefore, will not be redundantly included herein. When determining that another layer remains to be transformed (i.e., “Yes” in subprocess 320), process 300 may select the next layer (e.g., the immediately next layer in sequence) to be transformed and proceed to subprocess 330. Otherwise, when determining that no more layers remain to be transformed (i.e., “No” in subprocess 320), process 300 may end.

In subprocess 330, the layer that was selected in the most recent iteration of subprocess 320 is transformed from the classical layer in the supervisor network into a corresponding bipolar morphological layer in the student network. Subprocess 330 may be similar or identical to subprocess 230 in process 200. Thus, any description of subprocess 230 applies equally to subprocess 330, and therefore, will not be redundantly included herein. The resulting bipolar morphological layer is added to the student network.

In subprocess 340, the output of the newly created bipolar morphological layer is connected to the input of the next classical layer in the supervisor network that is subsequent to the selected classical layer in sequence (e.g., the immediately next layer in sequence). In other words, the student network will comprise all of the bipolar morphological layers that have been created in prior iterations of subprocess 330 and any classical layers that have not yet been transformed. If the current layer being processed is the final layer of the artificial neural network, subprocess 340 may be omitted, since there is no next classical layer. In this case, the output of the newly created bipolar morphological layer will be the output layer of the student network.

It should be understood that the input of the newly created bipolar morphological layer is connected to the output of an immediately preceding morphological layer, if any, in the student network. In the event that the bipolar morphological layer is the initial layer of the student network, the input of the newly created bipolar morphological layer is simply the input to the student network.

In subprocess 350, the error between the classical layer and the newly created corresponding bipolar morphological layer may be incorporated into the loss function for training the student network. For example, a measure of error, between the output

$${y}_{s}^{i}$$

of the corresponding classical layer in the supervisor network and the output

$${y}_{t}^{i}$$

of the newly created corresponding bipolar morphological layer in the student network, is incorporated into the loss function. This measure of error may comprise the root-mean-square error between the output

$${y}_{s}^{i}$$

of the classical layer and the output

$${y}_{t}^{i}$$

of the corresponding bipolar morphological layer. Alternatively, a different measure of error may be added to the loss function. In an embodiment, the overall loss function L may be defined as follows:

$$L = β {\sum }_{i = 1}^{m} {H}_{mse} ( {y}_{s}^{i} , {y}_{t}^{i} ) + α \{ {H}_{cross} ( {y}_{s} , {y}_{gt} ) + {H}_{cross} ( {y}_{t} , {y}_{gt} ) \}$$

In this case, the loss function L is calculated as a sum of the entropy of the output yₛ of the supervisor network and the output yₜ of the student network.

In subprocess 360, the resulting student network, including the transformed bipolar morphological layer(s) and any remaining classical layers, yet to be transformed, is trained to minimize the loss output by the loss function L. The supervisor network may also be trained in subprocess 360. For instance, the resulting student network may be trained and the supervisor network may be fine-tuned, on a training dataset with supervised learning, using the loss function L. This supervised learning may utilize a gradient method that is based on backpropagating the error calculated by the loss function L. In other words, subprocess 360 may comprise training both the supervisor network and the student network using a loss function that incorporates an error between the selected layer in the supervisor network and the corresponding bipolar morphological layer in the student network, for example, utilizing a gradient method that is based on backpropagating error calculated by the loss function.

In subprocess 370, the newly created bipolar morphological layer is fixed. In other words, the weights in the newly created bipolar morphological layer are fixed, such that they will not change in future iterations of subprocess 360. In addition, the corresponding classical layer in the supervisor network may be fixed, such that the weights in the corresponding classical layer will not change in future iterations of subprocess 360.

To summarize, in process 300, the student network, representing the bipolar morphological neural network, is built sequentially layer by layer. After each layer is transformed into a bipolar morphological layer, a measure of error (e.g., root-mean-square error), between the transformed bipolar morphological layer in the student network and the corresponding classical layer in the supervisor network, is incorporated into the loss function. The output of the bipolar morphological layer is connected to the input of the next classical layer in the supervisor network, and the student network is trained to minimize the error calculated by the loss function. After training, the transformed layers are fixed throughout the training of subsequently transformed layers. At the end of process 300, the student network is a full, trained bipolar morphological neural network, which may then be evaluated and/or deployed.

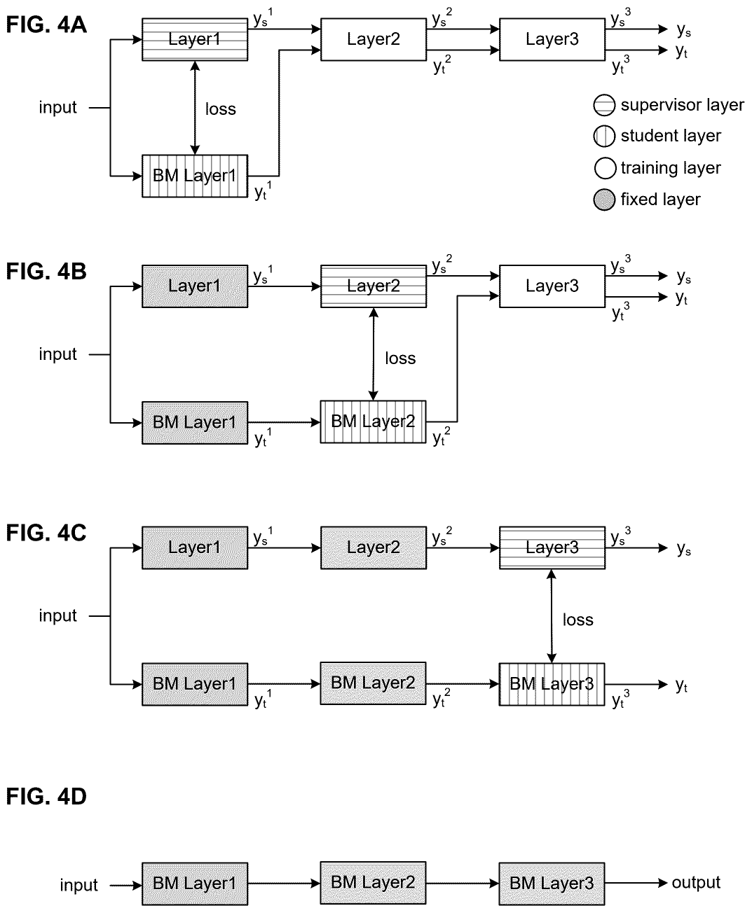

FIGS. 4A-4D illustrate the operation of process 300, according to an example. For ease of explanation, the construction of a simple three-layer student network is illustrated, with each of the three layers of the supervisor network being processed by an iteration of subprocesses 330-370. It should be understood that a supervisor network of any size may be processed in this manner to construct and train a corresponding bipolar morphological neural network of the same size.

Initially, as illustrated in FIG. 4A, Layer1 of the supervisor network is transformed into BM Layer1 of the student network (e.g., in subprocess 330), and the output of BM Layer1 of the student network is connected to the input of Layer2 of the supervisor network (e.g., in subprocess 340). Then, a measure of error between BM Layer1 of the student network and Layer1 of the supervisor network is incorporated into the loss function (e.g., in subprocess 350), and the student and supervisor networks are trained (e.g., in subprocess 360). After training, Layer1 and BM Layer1 are fixed (e.g., in subprocess 370).

Next, as illustrated in FIG. 4B, Layer2 of the supervisor network is transformed into BM Layer2 of the student network (e.g., in subprocess 330), and the output of BM Layer2 of the student network is connected to the input of Layer3 of the supervisor network (e.g., in subprocess 340). Then, a measure of error between BM Layer2 of the student network and Layer2 of the supervisor network is incorporated into the loss function (e.g., in subprocess 350), and the student and supervisor networks are trained (e.g., in subprocess 360). After training, Layer2 and BM Layer2 are fixed (e.g., in subprocess 370).

Next, as illustrated in FIG. 4C, Layer3 of the supervisor network is transformed into BM Layer3 of the student network (e.g., in subprocess 330). In this case, the output of BM Layer3 of the student network is the final output of the student network (e.g., in which case, subprocess 340 may be omitted). A measure of error between BM Layer3 of the student network and Layer3 of the supervisor network is incorporated into the loss function (e.g., in subprocess 350), and the student and supervisor networks are trained (e.g., in subprocess 360). After training, Layer3 and BM Layer3 are fixed (e.g., in subprocess 370), and the student network represents a full, trained bipolar morphological neural network, as illustrated in FIG. 4D.

### 7. MAXIMUM APPROXIMATION

The layer-by-layer knowledge distillation of process 300 makes it possible to level out the consequences of accumulated error by fine-tuning the supervisor network. However, when training using backpropagation (e.g., in subprocess 360), the updating of weights is slow, due to the presence of the maximum operations. Accordingly, in an embodiment, continuous approximations of the maximum operations are used instead of the actual maximum operations during training of the student network. In other words, during construction and training of the student network in process 300, each maximum operation in each bipolar morphological neuron may be converted into an approximation of the maximum operation. After training and prior to deployment of the student network, these approximations of the maximum operation may then be converted into actual maximum operations.

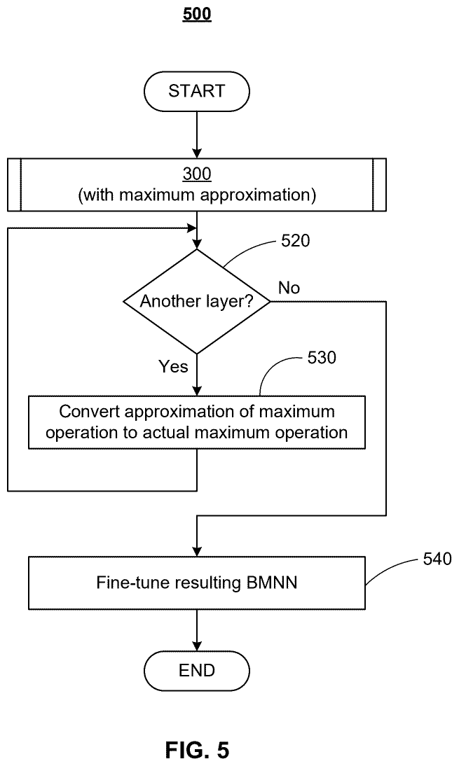

FIG. 5 illustrates an example process 500 for training a bipolar morphological neural network using layer-by-layer knowledge distillation and maximum approximation, according to an embodiment. Process 500 may be implemented in software (e.g., in system 100), in hardware, or in a combination of software and hardware. While process 500 is illustrated with a certain arrangement and ordering of subprocesses, process 500 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Initially, the bipolar morphological neural network may be trained as described in process 300. However, during the training in subprocess 360, each bipolar morphological layer utilizes an approximation of the maximum operation instead of the actual maximum operation, in order to increase the speed at which the weights in the bipolar morphological layers are updated. In an embodiment, the approximation of the maximum operation may comprise one of the following (see Ref15, Ref16):

$${S}_{morph} ( x ) = \frac{{\sum }_{i = 1}^{n} {x}_{i} {e}^{α {x}_{i}}}{{\sum }_{i = 1}^{n} {e}^{α {x}_{i}}}$$

$${L}_{m o r p h} ( x ) = \frac{{\sum }_{i = 1}^{n} {x}_{i}^{α + 1}}{{\sum }_{i = 1}^{n} {x}^{α}}$$

$$LSE ( x ) = \frac{ln {\sum }_{i = 1}^{n} {x}_{i} {e}^{α {x}_{i}}}{α}$$

wherein α is the temperature parameter that is responsible for the degree of approach to the maximum, and e is Euler's number, which is also known as the exponential constant. In an embodiment, the log-sum-exp (LSE) function, which may also be referred to as the RealSoftMax function or multivariable SoftPlus function, is used as the approximation of the maximum operation.

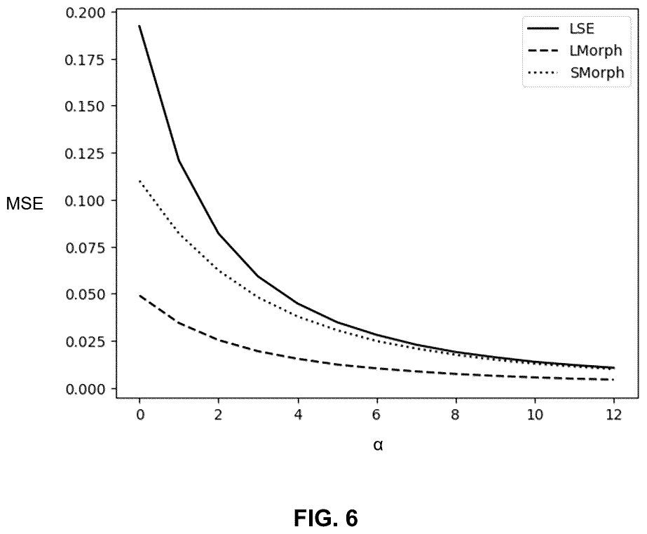

FIG. 6 illustrates the mean-square error (MSE) over values of a for each of the three continuous approximations of the maximum operation, according to an experiment. In particular, the average absolute error of the deviation of each approximation of the maximum operation from the maximum value, depending on the value of a, for averages values within an LeNet-like artificial neural network, is depicted. As illustrated, each approximation of the maximum operation is fairly accurate, and the approximations practically coincide with each other for α>20. When the approximations of the maximum operation are used in bipolar morphological neurons with values of α that are not too large, a larger number of weights can be updated in each step of the error backpropagation (e.g., in subprocess 360) than when using the actual maximum operation. This potentially improves the learning ability of the student network.

In subprocess 520, it is determined whether another layer remains to be considered in the bipolar morphological neural network that was produced by process 300 using the continuous approximation of the maximum operation. In particular, subprocesses 520-530 will iterate through each layer in the bipolar morphological neural network. When another layer remains to be considered (i.e., “Yes” in subprocess 520), process 500 selects the next layer to be considered and proceeds to subprocess 530. Otherwise, when no more layers remain to be considered (i.e., “No” in subprocess 520), process 500 proceeds to subprocess 540.

In subprocess 530, each approximation of the maximum operation in the selected layer is converted to the actual maximum operation. In particular, because the primary purpose of the bipolar morphological neural network is to replace multiplication operations with addition operations and addition operations with maximum operations, and since each continuous approximation of the maximum operation utilizes multiplication and division operations to speed up training, these continuous approximations are replaced with the actual maximum operations prior to operation of the bipolar morphological neural network. It should be understood that the weights of the bipolar morphological neural network are fixed at this point, such that the weights are not changed in subprocess 530.

In subprocess 540, the resulting bipolar morphological neural network, with the actual maximum operations, may be fine-tuned. This fine-tuning may be similar or identical to the training in subprocess 360, and therefore, will not be redundantly described herein.

In summary, to train the bipolar morphological neural network using knowledge distillation, continuous approximations (e.g., LSE function) of the maximum operation are used in a first stage of training (i.e., process 300), and actual maximum operations are used in a second stage of training (i.e., subprocess 540). The result is a bipolar morphological neural network, representing a computationally simpler approximation of a classical artificial neural network, that is not inferior to the classical artificial neural network in terms of accuracy.

### 8. EXAMPLE APPLICATIONS

Once constructed and trained via process 200, 300, or 500, the resulting bipolar morphological neural network may be deployed for operation. Deployment of the bipolar morphological neural network may comprise copying or moving the bipolar morphological neural network to a production environment. For instance, the deployed bipolar morphological neural network may reside at an address (e.g., in a microservices architecture) at which it can be accessed via an application programming interface (API), incorporated into an overarching software application, and/or the like.

Once deployed, the bipolar morphological neural network may operate on inputs to perform whatever task it was trained to perform. It should be understood that the bipolar morphological neural network will be trained to perform the same task as the classical artificial neural network from which it was derived. In other words, the student network performs the same task as the supervisor network. For instance, in an embodiment in which the classical artificial neural network comprises a convolutional neural network, the bipolar morphological neural network may perform any task that a convolutional neural network is suited to perform.

In an embodiment, the task performed by the classical artificial neural network and the bipolar morphological neural network may be an image-processing task. For instance, the image-processing task may be a task to be performed as part of computer vision (e.g., for an autonomous vehicle, robot, surveillance or other monitoring, etc.). As examples, the image-processing task may include, without limitation, recognizing at least one object within an input image (e.g., object recognition for computer vision), classifying an input image into one of a plurality of classifications, optical character recognition, or the like.

### 9. EXPERIMENTAL RESULTS

To assess the performance of the disclosed bipolar morphological neural network, trained using the layer-by-layer knowledge distillation disclosed herein, experiments were performed using the MNIST and CIFAR10 datasets.

In a first experiment, a bipolar morphological neural network, having a five-layer LeNet-like architecture and using a four-branch BM neuron model, was tested using each of the Sₘₒᵣₚₕ, Lₘₒᵣₚₕ, and LSE approximations of the maximum operation. In particular, the artificial neural network to be transformed consisted of five convolutional layers (e.g., 3×3 kernels, with sixteen filters in the first layer, and thirty-two filters in the four subsequent layers), each utilizing a Rectified Linear Unit (ReLU) as the activation function, and followed by a fully-connected SoftMax layer to produce the output classifications. In this first experiment, the bipolar morphological neural network was trained to classify images of handwritten digits into one of the ten possible digits.

In the first experiment, four different training methods were tested: direct training; layer-by-layer training without fixation; layer-by-layer training with fixation; and knowledge distillation. In direct training, a classical training method based on backpropagation and gradient was used. In layer-by-layer training without fixation, process 200 was used. In layer-by-layer training with fixation, layer-by-layer transformation, with additional training that fixes the weights after transformation and additional training of each layer, was used. In knowledge distillation, process 300 was used. The temperature parameter a was determined by firstly training the artificial neural network with a trainable value of a in each layer, and then fixing the values of a, with subsequent experiments performed using a constant value of a for each layer.

The following table depicts the accuracy of the bipolar morphological neural network produced by each training method in the first experiment, for each of the classical artificial neural network, a bipolar morphological neural network that did not use a continuous approximation of the maximum operation, a bipolar morphological neural network that used the Sₘₒᵣₚₕ function as the continuous approximation of the maximum operation, a bipolar morphological neural network that used the Lₘₒᵣₚₕ function as the continuous approximation of the maximum operation, and a bipolar morphological neural network that used the LSE function as the continuous approximation of the maximum operation:

| | | Layer-by-Layer | Layer-by-Layer | |
|---|---|---|---|---|
| | Direct | Training without | Training with | Knowledge |
| | Training | Fixation | Fixation | Distillation |
| Classical ANN | 0.9901 | — | — | — |
| BMNN | 0.1064 | 0.9648 | 0.9713 | 0.9893 |
| BMNN Sₘₒᵣₚₕ | 0.9231 | 0.9666 | 0.9737 | 0.9871 |
| BMNN Lₘₒᵣₚₕ | 0.1246 | 0.9361 | 0.9582 | 0.9612 |
| BMNN LSE | 0.9863 | 0.9871 | 0.9922 | 0.9945 |

Notably, the LSE approximation demonstrated the highest quality and produced a bipolar morphological neural network with slightly superior quality than the classical artificial neural network from which it was derived. In addition, the LSE approximation is the simplest of the three continuous approximations of the maximum operation in terms of computational complexity. Therefore, the LSE approximation was used in subsequent experiments.

In a second experiment, a bipolar morphological neural network, having a five-layer LeNet-like architecture and using the 1.5-branch BM neuron model described herein, was tested using the LSE function in place of the maximum operation. Again, the bipolar morphological neural network was trained to classify images of handwritten digits in the MNIST dataset into one of the ten possible digits. The following table depicts the accuracy of the bipolar morphological neural network produced by each training method in the second experiment, for each of the classical artificial neural network, a bipolar morphological neural network that utilized the LSE approximation of the maximum operation without replacing the LSE approximations with actual maximum operations after training, a bipolar morphological neural network that utilized the LSE approximation of the maximum operation with replacement of the LSE approximations with actual maximum operations (LSE-MAX) after training, and a bipolar morphological neural network that did not utilize any approximation of the maximum operation (MAX):

| | | | Layer-by-Layer |
|---|---|---|---|
| | Direct | Knowledge | Knowledge |
| | Training | Distillation | Distillation |
| Classical ANN | 0.9901 | — | — |
| 1.5-BMNN LSE | 0.1486 | 0.9998 | 0.9998 |
| 1.5-BMNN LSE - MAX | 0.1153 | 0.9821 | 0.9986 |
| 1.5-BMNN MAX | 0.0926 | 0.9786 | 0.9989 |

Notably, the bipolar morphological neural network with LSE approximation, trained using knowledge distillation, demonstrated excellent results, whereas the bipolar morphological neural network trained using direct training exhibited low accuracy. In addition, methods that used the actual maximum operation were unable to achieve the same accuracy as the classical artificial neural network. However, when layer-by-layer knowledge distillation was used to train the bipolar morphological neural network, the accuracy of the bipolar morphological neural network was higher than the accuracy of the classical artificial neural network.

The first and second experiments involved artificial neural networks with a small number of coefficients. In a third experiment, the artificial neural network had a ResNet-22 architecture (see Ref17), with three residual blocks containing sixteen, sixty-four, and two-hundred-fifty-six filters, respectively, and was trained to classify images from the CIFAR10 dataset. Each residual block contained two convolutional layers, whose outputs were summed with the input. The following table depicts the results of this third experiment:

| | | | Layer-by-Layer |
|---|---|---|---|
| | Direct | Knowledge | Knowledge |
| | Training | Distillation | Distillation |
| Classical ANN | 0.8643 | — | — |
| 1.5-BMNN LSE | 0.0982 | 0.8700 | 0.8700 |
| 1.5-BMNN LSE - MAX | 0.1033 | 0.8527 | 0.8661 |
| 1.5-BMNN MAX | 0.1084 | 0.8514 | 0.8669 |

Notably, the bipolar morphological neural network with LSE approximation, trained using knowledge distillation, still demonstrated the best results, but were slightly inferior to the classical artificial neural network in terms of accuracy. However, the quality of the bipolar morphological neural network was comparable to the quality of the classical artificial neural network. Training methods that used the actual maximum operation exhibited similar results as in the second experiment. The use of LSE approximation improved the speed of convergence in the error during training, and can potentially reduce training time in complex problems, relative to layer-by-layer knowledge distillation using the actual maximum operation.

Embodiments introduce a new 1.5-branch BM neuron model that increases the computational efficiency of a bipolar morphological neural network. In particular, the 1.5-branch BM neuron model reduces the number of computational branches of a neuron from four branches to one branch, while merely adding a computationally simple step of calculating offsets relative to the first quadrant. To accommodate this new 1.5-branch BM neuron, new training methods are disclosed that are based on layer-by-layer knowledge distillation and the use of a continuous approximation (e.g., LSE function) of the maximum operation. The experiments, described above, demonstrate that these training methods are effective for image-processing tasks, such as image classification. For example, the classification accuracy on the MNIST dataset, using a bipolar morphological neural network with an LeNet architecture, was 99.45%, and the classification accuracy on the CIFAR10 dataset, using a bipolar morphological neural network with a ResNet-22 architecture, was 86.69%. For comparison, the classification accuracies of a classical artificial neural network for these same tasks were 99.01% and 86.43%, respectively. Thus, the disclosed embodiments exhibit superior quality over state-of-the-art models.

### 10. REFERENCES

The following references, which may be referred to herein, are each hereby incorporated herein by reference as if set forth in full:
Ref1: Chernyshova Y. S., Sheshkus A. V., and Arlazarov, V. V., Two-step CNN framework for text line recognition in camera-captured images, IEEE Access, 2020, vol. 8, pp. 32587-32600;
Ref2: Kanaeva, I. A., Ivanova, Y. A., and Spitsyn, V. G., Deep convolutional generative adversarial network-based synthesis of datasets for road pavement distress segmentation, Comput. Optics, 2021, vol. 45, no. 6, pp. 907-916;
Ref3: Das, P. A. K. and Tomar, D. S., Convolutional neural networks based weapon detection: A comparative study, Fourteenth International Conference on Machine Vision (ICMV 2021), SPIE, 2022, vol. 12084, pp. 351-359;
Ref4: Bulatov, K. et al., Smart IDReader: Document recognition in video stream, 14th IAPR International Conference on Document Analysis and Recognition (ICDAR), IEEE, 2017, vol. 6, pp. 39-44;
Ref5: Zhao, Y., Wang, D., and Wang, L., Convolution accelerator designs using fast algorithms, Algorithms, 2019, vol. 12, no. 5, p. 112;
Ref6: Yao, Z. et al., Hawq-v3: Dyadic neural network quantization, International Conference on Machine Learning, PMLR, 2021, pp. 11875-11886;
Ref7: Tai, C. et al., Convolutional neural networks with low-rank regularization, arXiv: 1511.06067, 2015;
Ref8: Sun, X. et al., Pruning filters with L1-norm and standard deviation for CNN compression, Eleventh International Conference on Machine Vision (ICMV 2018), SPIE, 2019, vo. 11041, pp. 691-699;
Ref9: You, H. et al., Shiftaddnet: A hardware-inspired deep network, Adv. Neural Inf. Process. Syst., 2020, vol. 33, pp. 2771-2783;
Ref10: Chen, H. et al., AdderNet: Do we really need multiplications in deep learning? Proc. of the IEEE/CVF Conference on Computer Vision and Pattern Recognition, 2020, pp. 1468-1477;
Ref11: Limonova, E. E. et al., Bipolar morphological neural networks: Gate-efficient architecture for computer vision, IEEE Access, 2021, vol. 9, pp. 97569-97581;
Ref12: Limonova, E. E., Fast and gate-efficient approximated activations for bipolar morphological neural networks, Inf. Technol. Vychisl. Sist., 2022, No. 2, pp. 3-10;
Ref13: Hinton, G., Vinyals, O., and Dean, J., Distilling the knowledge in a neural network, arXiv: 1503.02531, 2015;
Ref14: Xu, Y. et al., Kernel based progressive distillation for adder neural networks, Adv. Neural Inf. Process. Syst., 2020, vol. 33, pp. 12322-12333;
Ref15: Kirszenberg, A. et al., Going beyond p-convolutions to learn grayscale morphological operators, Proc. of the First International Joint Conference on Discrete Geometry and Mathematical Morphology, DGMM 2021, Uppsala, Sweden, 2021, Cham: Springer, 2021, pp. 470-482;
Ref16: Calafiore, G. C., Gaubert, S., and Possieri, C., A universal approximation result for difference of log-sum-exp neural networks, IEEE Trans. Neural Networks Learn. Syst., 2020, vol. 31, no. 12, pp. 5603-5612; and
Ref17: He, K. et al., Deep residual learning for image recognition, Proc. of the IEEE Conference on Computer Vision and Pattern Recognition, 2016, pp. 770-778.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
acquire a supervisor network that comprises a trained first artificial neural network;
construct and train a student network, comprising a second artificial neural network, by, for each of a plurality of layers in the supervisor network, in sequence from an input to an output of the supervisor network,
transform the layer in the supervisor network into a corresponding bipolar morphological layer in the student network, wherein the bipolar morphological layer comprises at least one 1.5-branch model of a bipolar morphological neuron in which inputs to the bipolar morphological neuron are shifted to positive and weights within the bipolar morphological neuron are shifted to positive,
connect an output of the corresponding bipolar morphological layer to an input of a next layer in the supervisor network that is subsequent to the layer, and
train both the supervisor network and the student network using a loss function that incorporates an error between the layer in the supervisor network and the corresponding bipolar morphological layer in the student network; and
deploy the student network as a bipolar morphological neural network.

2. The method of claim 1, wherein acquiring the supervisor network comprises training the first artificial neural network.

3. The method of claim 2, wherein training the first artificial neural network comprises supervised learning that utilizes a gradient method with backpropagation of error.

4. The method of claim 1, wherein acquiring the supervisor network comprises receiving the first artificial neural network.

5. The method of claim 1, wherein constructing and training the student network further comprises, for each of the plurality of layers in the supervisor network, after training both the supervisor network and the student network using the loss function, fixing the layer in the supervisor network and the corresponding bipolar morphological layer in the student network.

6. The method of claim 1, wherein constructing and training the student network further comprises, for each of the plurality of layers in the supervisor network, connecting an input of the corresponding bipolar morphological layer to an output of an immediately preceding bipolar morphological layer, if any, in the student network.

7. The method of claim 1, wherein, during construction and training of the student network, each bipolar morphological layer utilizes an approximation of a maximum operation instead of an actual maximum operation.

8. The method of claim 7, wherein the approximation of the maximum operation is a log-sum-exp (LSE) function.

9. The method of claim 7, further comprising using the at least one hardware processor to, after constructing and training the student network and before deploying the student network, convert each approximation of the maximum operation in the bipolar morphological layers of the bipolar morphological neural network to the actual maximum operation.

10. The method of claim 9, further comprising using the at least one hardware processor to, after converting each approximation of the maximum operation to the actual maximum operation and before deploying the student network, fine-tuning the bipolar morphological neural network.

11. The method of claim 1, wherein the error between the layer in the supervisor network and the corresponding bipolar morphological layer in the student network comprises a measure of error between an output of the layer in the supervisor network and an output of the corresponding bipolar morphological layer in the student network.

12. The method of claim 11, wherein the measure of error is a root-mean-square error.

13. The method of claim 12, wherein the loss function is defined as:
$$L = β {\sum }_{i = 1}^{m} {H}_{mse} ( {y}_{s}^{i} , {y}_{t}^{i} ) + α \{ {H}_{c r o s s} ( {y}_{s} , {y}_{gt} ) + {H}_{c r o s s} ( {y}_{t} , {y}_{gt} ) \}$$
wherein L is the loss function, α and β are temperature parameters that control randomness, Hₘₛₑ is a root-mean-square error (RMSE) function, H_{cross} is a cross entropy function, m is a number of layers in the plurality of layers,
$${y}_{s}^{i}$$
is an output of layer i of the supervisor network,
$${y}_{t}^{i}$$
is an output of layer i of the student network, yₛ is an output of the supervisor network, yₜ is an output of the student network, and y_{gt} is a target output.

14. The method of claim 1, wherein each 1.5-branch model of the bipolar morphological neuron is defined as:
$$f ( \vec{x} ) = ϕ \{ exp {max}_{i = 1}^{n} [ ln ( {x}_{i} + Δ {x}_{i} ) + ln ( {v}_{i} + Δ {v}_{i} ) ] - Δ {x}_{i} {v}_{i} - Δ {v}_{i} {x}_{i} - Δ {x}_{i} Δ {v}_{i} \}$$
wherein ƒ(⋅) is the neuron, ϕ is an activation function, x is an input vector of input data, exp is an exponential function, max is a maximum operation, ln is a natural logarithm, n is a length of the input vector, xᵢ is a value at position i in the input vector, Δxᵢ is a displacement of xᵢ, v is a weight vector, vᵢ is a value at position i in the weight vector, and Δvᵢ is a displacement of vᵢ.

15. The method of claim 1, wherein the student network is trained to perform an image-processing task.

16. The method of claim 15, wherein the image-processing task comprises recognizing at least one object within an input image or classifying an input image into one of a plurality of classifications.

17. The method of claim 15, wherein the first artificial neural network is a convolutional neural network, and wherein each of the plurality of layers is a convolutional layer.

18. The method of claim 1, wherein training both the supervisor network and the student network utilizes a gradient method that is based on backpropagating error calculated by the loss function.

19. A system comprising:
at least one hardware processor; and
one or more software modules that are configured to, when executed by the at least one hardware processor, perform the method of claim 1.

20. A non-transitory computer-readable medium having instructions stored therein, wherein the instructions, when executed by a processor, cause the processor to perform the method of claim 1.
